(19) United States
(12) Patent Application Publication
(10) Pub. No.: US 2024/0430643 A1
(43) Pub. Date: Dec. 26, 2024

(54) DESTINATION VALIDATION METHOD AND SYSTEM

(71) Applicant: GM GLOBAL TECHNOLOGY OPERATIONS LLC, Detroit, MI (US)

(72) Inventors: Alaa M. Khamis, Courtice (CA); Yun Qian Miao, Waterloo (CA); Russell A. Patenaude, Macomb Township, MI (US)

(73) Assignee: GM GLOBAL TECHNOLOGY OPERATIONS LLC, Detroit, MI (US)

(21) Appl. No.: 18/338,718

(22) Filed: Jun. 21, 2023

(51) Int. Cl. H04W 4/029

(52) U.S. Cl. CPC H04W 4/029; H04W 84/12

(57) ABSTRACT

A method for confirming arrival at a target location includes comparing, by one or more controllers, properties of a plurality of identifying features of the target location with properties of a corresponding plurality of corresponding features of a present location to result in a plurality of comparisons. The method additionally includes identifying, by one or more controllers, the present location as the target location if the plurality of comparisons concludes that the present location is the target location. The properties of a plurality of identifying features of the target location include at least one property of one or more wireless communication networks expected to be detectable at the target location.

### INTRODUCTION

The present disclosure is in the field of routing and destination validation.

People periodically seek to travel to desired target locations, such as homes or businesses, for various purposes. Such purposes may be to deliver packages for a delivery service or for an online retailer. If a person is not familiar with a target location and, further, if the target location is in a densely populated area, the person may have difficulty finding the target location and confirming arrival there, as opposed to arrival at an erroneous other location. Further, similar street addresses of different buildings may cause a delivery person to inadvertently deliver a package to an incorrect location.

### SUMMARY

A method for confirming arrival at a target location includes comparing, by one or more controllers, properties of a plurality of identifying features of the target location with properties of a corresponding plurality of corresponding features of a present location to result in a plurality of comparisons. The method also includes identifying, by one or more controllers, the present location as the target location if the plurality of comparisons concludes that the present location is the target location. The properties of a plurality of identifying features of the target location include at least one property of one or more wireless communication networks expected to be detectable at the target location.

In a variation, the plurality of identifying features of the target location may include a visible street address number located at the target location. In an additional variation, the plurality of identifying features of the target location may include at least one visible exterior feature of a building at the target location. In yet another variation, the plurality of identifying features of the target location may include a walking profile of a route approaching the target location. The walking profile may include at least one of number of stairs in the walking profile, shape of the walking profile, length of the walking profile, and expected walking time to traverse the walking profile.

Alternatively, the one or more wireless communication networks may be WiFi networks and the at least one identifying feature may include SSIDs or BSSIDs of the wireless communication networks. Alternatively yet, the at least one identifying feature of the WiFi networks may include signal strengths of the networks. Further still, the at least one identifying feature of the WiFi networks may include radiofrequencies of the networks.

The method may additionally include using a geofence to confirm proximity to the target location before comparing properties of a plurality of identifying features of the target location with properties of a plurality of corresponding features of the present location.

The method may further comprise combining results of the plurality of comparisons to result in a confidence score, comparing the confidence score with a validation threshold, and identifying the present location as the target location if the confidence score is above the validation threshold.

Additionally still, the method may further include updating a database of properties of identifying features of the target location with a property of at least one identifying feature of the present location if the present location has been identified as the target location.

Another method for confirming arrival at a target location includes retrieving properties of a plurality of identifying features of the target location from a database populated based on prior observations made at the target location, comparing the properties of the plurality of identifying features of the target location with properties of a corresponding plurality of corresponding features of a present location to result in a plurality of comparisons, and identifying the present location as the target location if the plurality of comparisons concludes that the present location is the target location.

The plurality of identifying features of the target location may include at least one visible exterior feature of a building at the target location. Alternatively or additionally, the plurality of identifying features of the target location may include a walking profile of a route approaching the target location.

The method may further include updating a database of properties of identifying features of the target location with a property of at least one identifying feature of the present location if the present location has been identified as the target location.

An additional method for confirming arrival at a target location includes comparing a profile of wireless communication networks expected to be detectable at the target location with a profile of wireless communications networks detected at a present location, and identifying the present location as the target location if the comparison concludes that the present location is the target location. The profile of wireless communication networks expected to be detectable at the target location may include one or more SSIDs or BSSIDs. The profile of wireless communication networks expected to be detectable at the target location may also include signal strengths, at the target location, of the wireless communications networks. The profile of wireless communication networks expected to be detectable at the target location may additionally include radiofrequencies of the wireless communications networks. The profile of wireless communication networks expected to be detectable at the target location may include at least one vehicle-based WiFi network.

The above summary does not represent every embodiment or every aspect of this disclosure. Other possible features and advantages will be readily apparent from the following detailed description of the embodiments for carrying out the disclosure when taken in connection with the accompanying drawings and appended claims. Further, combinations and subcombinations of elements described in this disclosure are expressly included in this disclosure.

### BRIEF DESCRIPTION OF THE DRAWINGS

FIG. 1 shows a person approaching a building.

FIG. 2 is a flowchart illustrating a portion of a method for validating that the building of FIG. 1 is the person's intended target location.

FIG. 3 is a flowchart that further illustrates the method for validating that the building of FIG. 1 is the person's intended target location.

FIG. 4 is an image of exterior features of a building as shown on a mobile phone.

FIG. 5A is a table containing properties of WiFi networks expected at a target location.

FIG. 5B is a table containing characteristics of WiFi networks detected at a current location.

FIG. 6 shows examples of features that may be used in the example destination validation method illustrated in FIG. 2 and FIG. 3.

FIG. 7 is a flowchart that shows an enhancement of a portion of the flowchart illustrated at FIG. 3.

### DETAILED DESCRIPTION

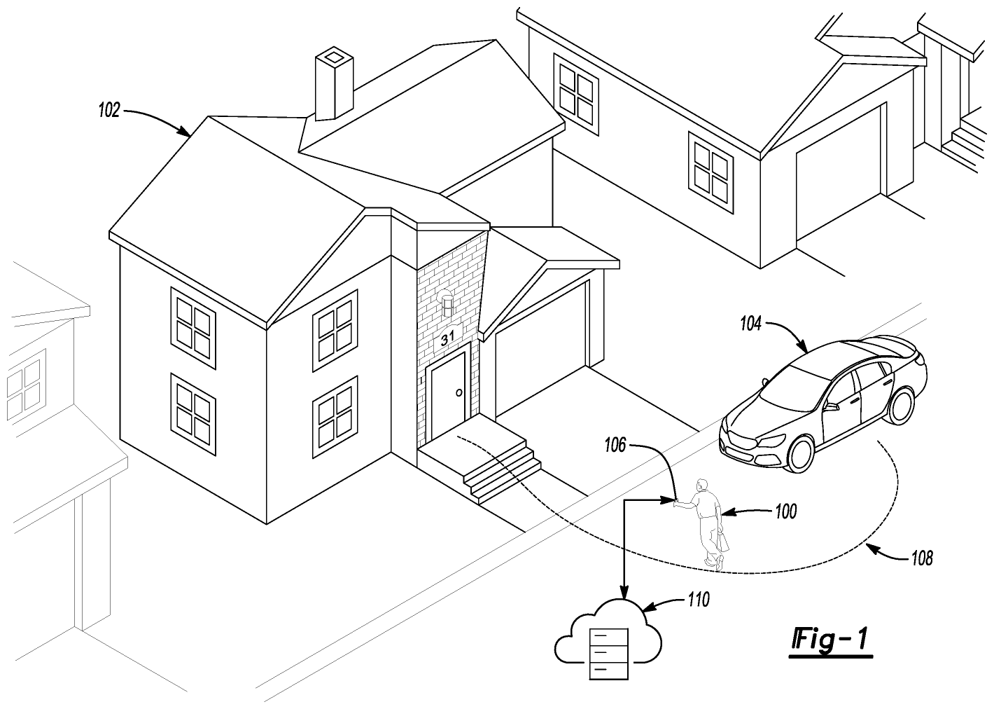

Referring first to FIG. 1, a person 100 such as a delivery person may be seeking to find a target location 102, such as a home or a business. Target location 102 may have other structures adjacent or attached thereto. Person 100 may have arrived in a vehicle 104 and may now be walking to target location 102 in order to deliver a package intended for an occupant of target location 102. Person 100 may be carrying a smartphone 106. Person 100 may follow a path 108 from vehicle 104 to the front door of target location 102.

Person 100 may be someone who is not familiar with the neighborhood in which target location 102 is situated, and/or person 100 may be a temporary worker or one who is new to the job. Therefore, person 100 may be unsure about which exact building is target location 102. This may particularly be an issue in areas of relatively dense placement of buildings and areas where global positioning system (GPS) technology may not be reliably available. This may also be true where the delivery is intended for a dweller of a multi-unit apartment or commercial building.

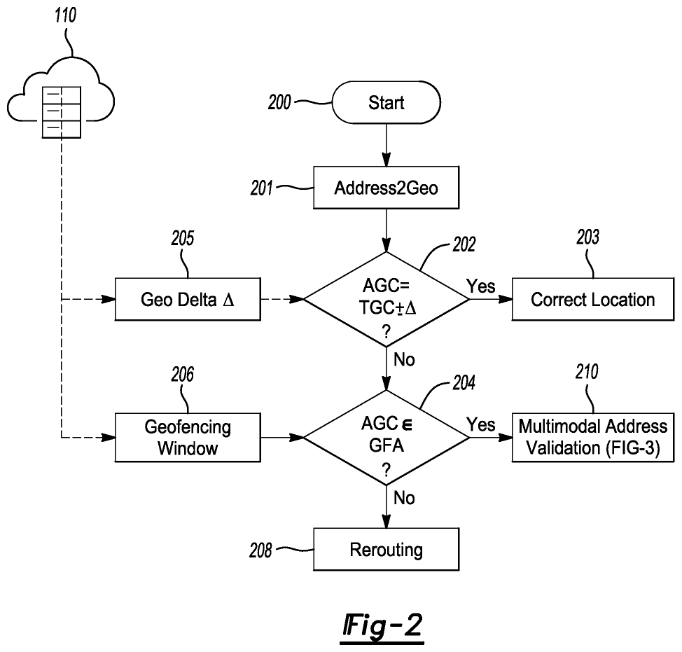

A method and system for helping person 100 reliably confirm arrival at target location 102 may begin with additional reference to FIG. 2, beginning at block 200. At block 201, the geographic coordinates of the address of target location 102 are retrieved from any of several databases where such information is available, which may include database 110. Also, a margin of error (a “geographic delta”) A may be retrieved (block 205). At block 202, the actual geographic coordinates (“AGC”) of vehicle 104, in which person 100 may be driving to target location 102, or smartphone 106 are compared with the geographic coordinates (“TGC”) of target location 102. If the coordinates match within the margin of error A, it may be concluded that person 100 is at target location 102, as reflected in block 203. Margin of error A may be retrieved from database 110. Margin of error A may be fixed, or it may be variable, a function of, say, the density of buildings in the vicinity of target location 102; a larger error may be tolerated if the buildings in a given area are spaced further apart than if the buildings are closer together. If the geographic coordinates are not matched within the margin of error A, it is then considered at block 204 whether person 100 is within suitable geofencing window (block 206) that approximates the location of target location 102. The geofencing window may also be variable, depending, for instance, on the density of buildings in the vicinity of target location 102. If person 100 is not within the geofenced bounds that approximate the target location, then it may be concluded that person 100 is not at target location 102. Person 100 may then be informed of this on smartphone 106 and rerouted (block 208) or use an alternative method of finding his or her destination. However, if person 100 is within the geofenced bounds that approximate target location 102, then the validation method may continue at block 210, where a multimodal address validation may commence.

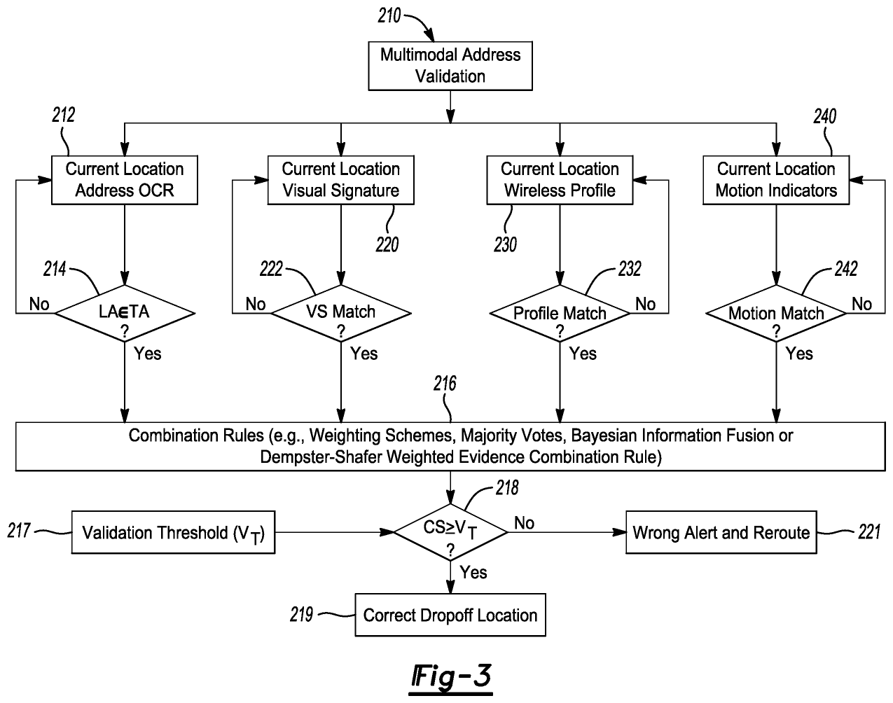

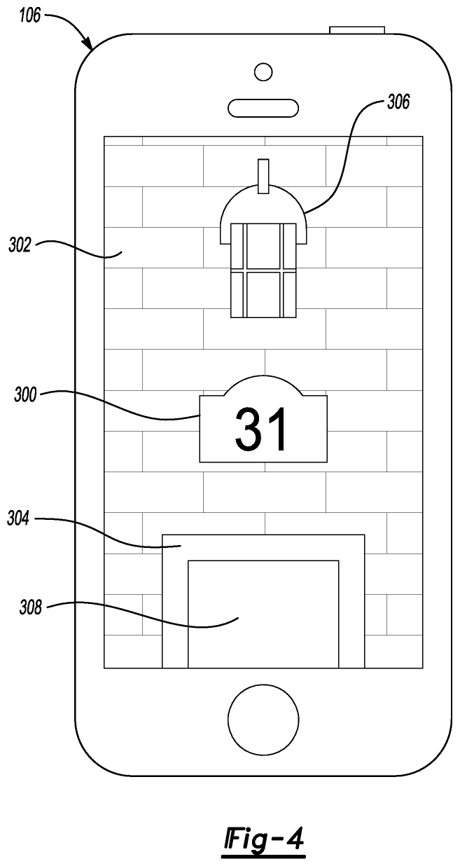

The multimodal address validation of block 210 is further described with reference to FIG. 3. There, one or more of a plurality of address validation procedures may take place. At block 212, optical address recognition may take place. Referring also to FIG. 4, the camera of smartphone 106 may be used by person 100 to take an image of an address plate 300 at the building where person 100 is located and perform optical character recognition (OCR) on address plate 300 to determine the numbers and/or letters contained thereon. (Alternatively, if target location 102 is a unit of an apartment or other multiunit building. OCR may be performed on numbers and/or letters that identify the unit within the building.) At block 214, it is determined whether the address (LA) read by optical address recognition of block 212 is the address (TA) of target location 102. If no, block 212 may be repeated, with the possibility that a repeated attempt to recognize the characters on address plate 300 may yield a passing result. If the result of the test at block 214 is yes, however, then the routine continues to block 216.

At block 220, and with continuing reference to FIG. 4, the image captured by smartphone 106 of the building at which person 100 is located may be compared to database-stored visibly observable characteristics (VS) of target location 102. Such characteristics may include color, texture, and/or composition of the external siding 302 (e.g., brick, wood, vinyl) of the building. The characteristics may also include the existence, colors, sizes, shapes, and/or textures of doorframe 304 and door 308 and the existence, colors, sizes, shapes, and/or textures of other identifying elements such as exterior coach lamp 306. Several of the foregoing factors (e.g., color match, texture match, key points of the structure) may be evaluated for sufficient matches and the results of such evaluations may be combined in a majority-rule or other combination scheme to determine whether the test at block 222 results overall in a sufficient match. If yes, then the routine continues to block 216. If no, then block 220 may be repeated by instructing person 100 to capture another visual signature using the camera on smartphone 106.

At block 230, it may be considered whether a profile of the wireless communications (e.g., WiFi) networks in the vicinity of person 100 is a sufficient match to a WiFi profile expected at target location 102. The WiFi profile expected at target location 102 may be stored in a database, as will be further discussed hereinafter. The WiFi profile expected at target location 102 may comprise WiFi networks of homes, commercial buildings, vehicles, and internet service provider “hotspots” in the vicinity of target location 102. Of particular advantage, a provider of WiFi services (such as a vehicle manufacturer) to a large population of vehicles may have considerable knowledge about the WiFi networks of vehicles of owners residing in the vicinity of target location 102. Such networks may be expected to be detectable to a person who has arrived at target location 102. At block 232, it is considered whether the WiFi profile at the present location of person 100 suggests that person 100 is at target location 102. Various properties of the WiFi profile in the vicinity of person 100 may be considered at block 232. For instance, the existence of SSIDs (Service Set Identifiers) or BSSIDs (Basic Service Set Identifiers) of WiFi networks that would be expected to be in the vicinity of target location 102 may be considered. Additionally, the signal strengths of WiFi networks in the vicinity of person 100 may be compared with the signal strengths of WiFi networks that would be expected at target location 102. Further, then, the radiofrequencies of WiFi networks in the vicinity of person 100 may be compared with the radiofrequencies of WiFi networks that would be expected in the vicinity of target location 102. If the WiFi profile in the vicinity of person 100 is sufficiently close to that which would be expected at target location 102 to suggest that person 100 may be at target location 102, then the routine may continue at block 216. If, however, the WiFi profile in the vicinity of person 100 is not sufficiently close to that which would be expected in the vicinity of target location 102 to suggest that person 100 may be at target location 102, then the routine may return to block 230.

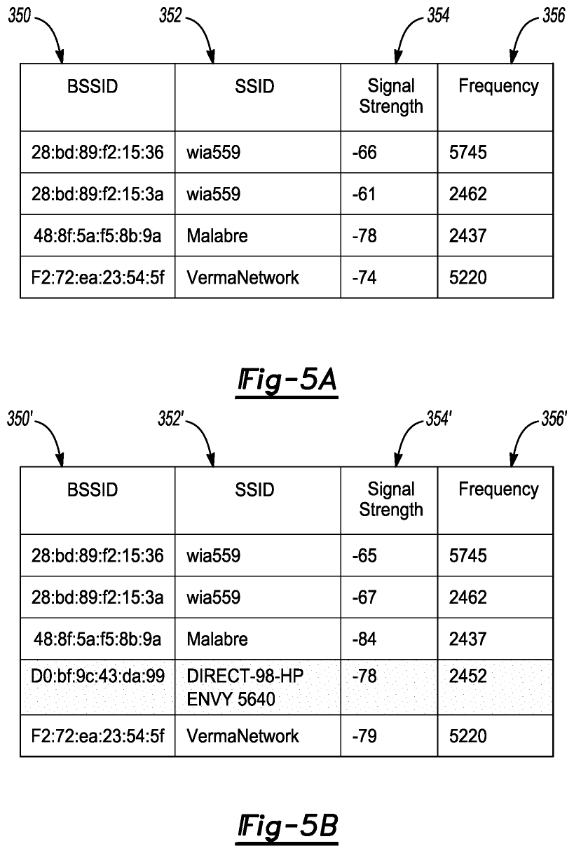

FIG. 5A is an illustration of how the WiFi profile may be expected to look at target location 102, including one or more of BSSID 350, SSID 352, signal strength 354, and radiofrequency 356 of the respective WiFi networks. FIG. 5B is an illustration of how the WiFi profile may look at the actual location of person 100, including BSSID 350′, SSID 352′, signal strength 354′ and radiofrequency 356′ for each of the WiFi networks that is detectable at the actual location of person 100. As a method for comparing the two to determine whether they are sufficiently close to suggest that person 100 is at target location 102, the Hamming distance between the data in the two tables may be calculated.

At block 240, a motion matching routine may be entered. There, database-stored characteristics regarding a path 108 approaching target location 102 may be accessed. Such characteristics may include the distance to be walked from, say, the street to the front porch or front door of target location 102. The characteristics may also include the time needed to walk from, say, the street to the front porch or front door of target location 102. The characteristics may additionally include the number of steps leading up or down from the front walk to the front porch of target location 102. The characteristics may further include the shape of the walking route from, say, the street to target location 102. The characteristics may also include the change of altitude from the ground floor of a multidwelling building such as an apartment house or a commercial building up to the floor where target location 102 is located. Several of the foregoing factors may be evaluated for sufficient matches and the results of such evaluations may be combined in a majority-rule or other combination scheme to determine whether the test at block 242 results overall in a sufficient-enough match to be a positive indicator that person 100 is at target location 102.

If the path followed by person 100 sufficiently matches the expected path to target location 102, then the routine may continue at block 216. If not, then the motion matching may be attempted again at block 240.

At block 216, the inputs from any of the tests 214, 222, 232, and 242 that may have been performed and, further, that were considered to have successfully-enough passed, may be combined. The combination may be according to several methods. For instance, a weighting scheme may be employed, where the factor considered to be most reliable in determining whether person 100 has arrived at target location 102 may be given the most weight. Alternatively, a majority vote scheme may be used, where it may be determined whether more tests were successful than not successful. Additional schemes may include Bayesian information fusion and the Dempster-Shafer weighted evidence combination rule. The result of the analysis at block 216 may be a conclusion regarding whether person 100 has arrived at target location 102. The result of the analysis at block 216 may also be a confidence score CS that reflects the level of confidence that person 100 has successfully arrived at target location 102.

At block 218, then, confidence score CS may be tested against a validation threshold V_{T} (block 217). If the confidence score is sufficiently high, then the routine proceeds to block 219, where person 100 is informed, say, by the app on person 100's smartphone 106 or via text, that she or he is at target location 102. If the confidence score is not sufficiently high, then an alert may be given to person 100 at block 221 that person 100 is not at target location 102. Person 100 may then seek alternative assistance in finding target location 102, say, by making a telephone call for assistance, or the routing system which brought person 100 to her/his current location may make another attempt to route person 100 to target location 102.

Database 110 may be employed to store multiple identifying characteristics of each potential target location in a digital profile (that is, a database record) having a unique digital identifier for each potential target location. Those stored identifying characteristics may be used, at least in part, as the basis for the various comparisons undertaken at blocks 214, 222, 232, and 242. Further, then, once a person 100 has successfully reached a target location such as target location 102, the results from the travel of person 100 to target location 102 may be used to update and enrich the digital profile for target location 102. For instance, the number of steps needed for person 100 to arrive at the front door of target location 102 may be recorded in the database 110 by automatic feedback via the app running on smartphone 106, which may be equipped with a step-counting function. Further, the visual characteristics of the exterior of target location 102 may be recorded in the database in order to update and enrich the digital profile for target location 102. The existence and visual characteristics of other visible markers (e.g., fire hydrants, basketball hoops, vehicle makes and models in the driveway) captured during the travel of person 100 to target location 102 may also be recorded in the digital record and used for subsequent visual comparisons (say, at block 232) for people seeking to travel to target location 102. The result of the database updates may be that the record for target location 102 in database 110 may be more reliable as a basis for future comparisons when person 100 or another person makes future trips to target location 102. Further, the result of such future comparisons may be a conclusion with higher confidence whether the person seeking to reach target location 102 has in fact successfully done so.

The existence of hazards, such as unfriendly dogs, may also be uploaded by person 100 into the digital profile of target location 102, so that future people seeking to travel to target location 102 may be warned about such hazards.

Database 110 may be a cloud-based database that communicates with smartphone 106 via wireless communication. Database 110 may reside at the “back office” of a provider of telecommunications-based services, such as an automobile manufacturer. OnStar®, a telecommunications service provider affiliated with General Motors, is one such provider. Database 110 may alternatively reside in a “back office” associated with a delivery service or online retailer with which person 100 is associated. The various calculations, comparisons, and other operations described herein may be run by the app in smartphone 106, remotely via cloud computing or in a respective “back office,” or they may be distributed among a combination of any of the foregoing. In each case, the respective controllers contain sufficient electronic resources (including but not limited to microprocessor, memory, inputs, outputs, and software) to perform the functions ascribed to them herein.

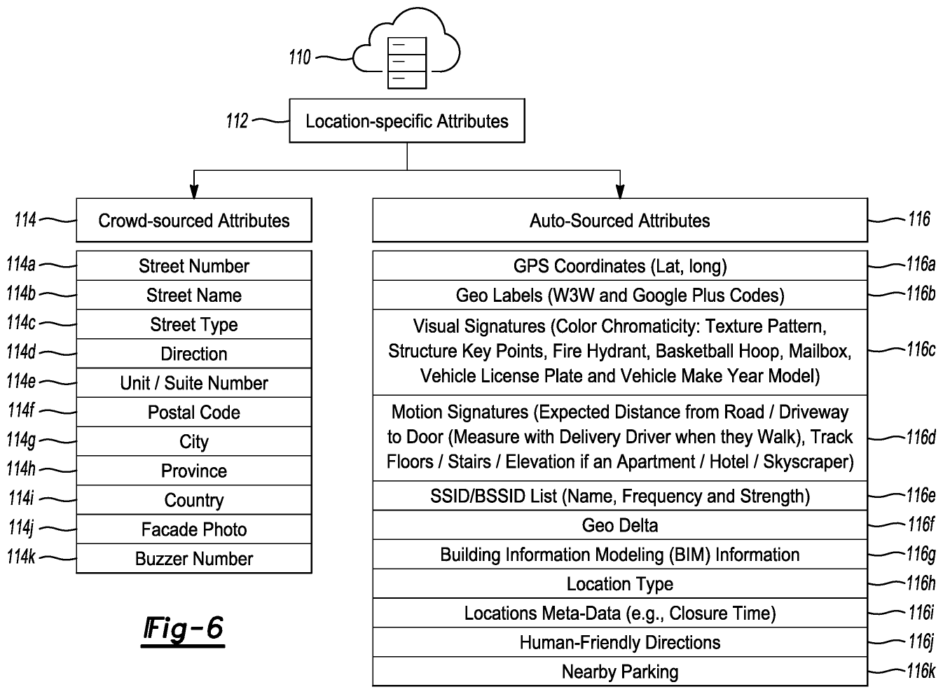

Data that may be stored in database 110 are illustrated with further reference to FIG. 6, where location-specific attributes 112 for possible target locations may be stored. For the purposes of the present example disclosure, the data are categorized as “crowd-sourced attributes” 114 and “auto-sourced attributes” 116, and some may be sourced in both ways or in the other way.

Crowd-sourced attributes 114 may include attributes that may be input by users, such as street address number 114a, street name 114b, street type (for instance, paved/unpaved, number of lanes) 114c, direction 114d, unit or suite number 114e, postal (or ZIP) code 114f, city 114g, state or province 114h, country 114i, façade photo 114j, and buzzer number 114k (in the case that target location 102 is a multiunit building).

Auto-sourced attributes 116 may be attributes that are automatically updated in database 110 and may include GPS coordinates (latitude, longitude) 116a, GEO labels (e.g., What Three Words (“W3W”) and/or Google Plus codes) 116b, visual signatures 116c, motion signature 116d, WiFi network list (SSID, BSSID, network radiofrequency, and signal strength) 116e, Geo Delta 116f (see block 205, FIG. 2), building information modeling (“BIM”) information 116g, location type (e.g., single-family home, multiunit housing, commercial, industrial) 116h, metadata associated with the location (e.g., opening and closing times and days) 116i, human-friendly direction descriptions 116j, and nearby parking 116k.

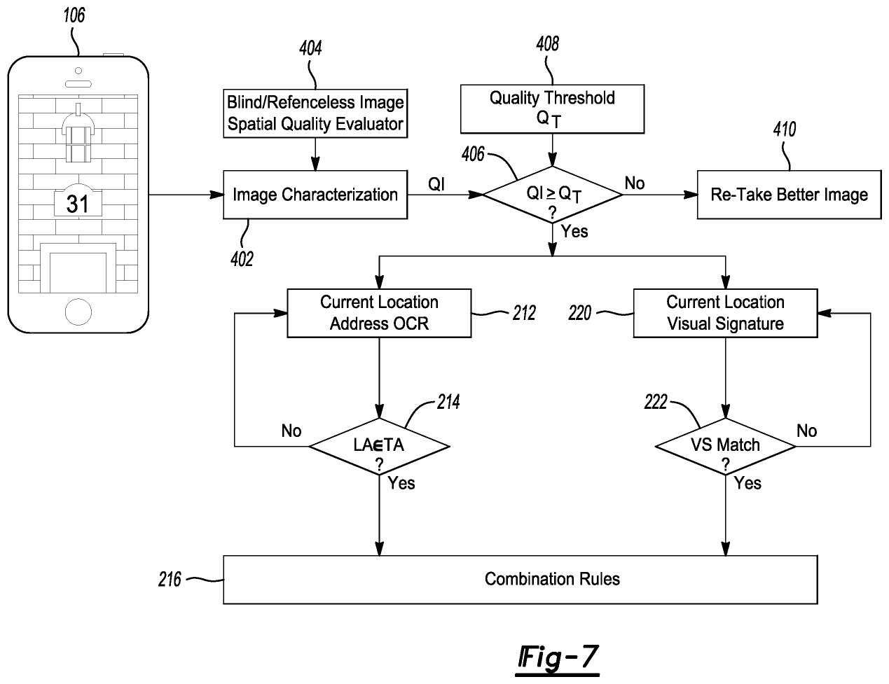

A method for validating the image captured by smartphone 106 before being processed at blocks 212 and 220 is illustrated with further reference to FIG. 7. Here, the quality of the image captured by smartphone 106 is characterized at block 402 by a blind/referenceless spatial quality evaluator 404. The resulting evaluated quality QI of the image is compared at block 406 with a quality threshold QT from block 408. If the quality QI of the image is better than the quality threshold QT, then processing may continue at blocks 212, 214, 220, 222 and 216, as described previously with reference to FIG. 3. (Note that block 216 as illustrated in FIG. 7 intentionally omits, for clarity, the entries to that block from blocks 232 and 242, which were described with reference to FIG. 3). However, if the image quality QI is not better than the quality threshold QT, then person 100 may be instructed at block 410 to take another photo with smartphone 106, with the aim of capturing a better image. The results of the tests at blocks 214 and 222, if positive, feed to the combination rules at block 216, as previously discussed with reference to FIG. 3.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for confirming arrival at a target location, the method comprising:
comparing, by one or more controllers, properties of a plurality of identifying features of the target location with properties of a corresponding plurality of corresponding features of a present location to result in a plurality of comparisons; and
identifying, by one or more controllers, the present location as the target location if the plurality of comparisons concludes that the present location is the target location;
wherein the properties of a plurality of identifying features of the target location include at least one property of one or more wireless communication networks expected to be detectable at the target location.

2. The method of claim 1, wherein the plurality of identifying features of the target location includes a visible street address number located at the target location.

3. The method of claim 1, wherein the plurality of identifying features of the target location includes at least one visible exterior feature of a building at the target location.

4. The method of claim 1, wherein the one or more wireless communication networks are WiFi networks and the at least one property of the one or more wireless communication networks includes SSIDs or BSSIDs of the wireless communication networks.

5. The method of claim 4, wherein the at least one property of the one or more wireless communication networks includes signal strengths of the one or more wireless communication networks.

6. The method of claim 4, wherein the at least one property of the one or more wireless communication networks includes radiofrequencies of the one or more wireless communication networks.

7. The method of claim 1, wherein the plurality of identifying features of the target location includes a walking profile of a route approaching the target location.

8. The method of claim 7, wherein the walking profile includes at least one of number of stairs in the walking profile, shape of the walking profile, length of the walking profile, and expected walking time to traverse the walking profile.

9. The method of claim 1, further comprising:
using a geofence to confirm proximity to the target location before comparing properties of a plurality of identifying features of the target location with properties of a plurality of corresponding features of the present location.

10. The method of claim 1, further comprising:
combining results of the plurality of comparisons to result in a confidence score;
comparing the confidence score with a validation threshold; and
identifying the present location as the target location if the confidence score is above the validation threshold.

11. The method of claim 1, further comprising updating a database record of properties of identifying features of the target location with a property of at least one identifying feature of the present location if the present location has been identified as the target location, wherein the database record is identified by a unique digital identifier.

12. A method for confirming arrival at a target location, the method comprising:
retrieving properties of a plurality of identifying features of the target location from a database populated based on prior observations made at the target location;
comparing the properties of the plurality of identifying features of the target location with properties of a corresponding plurality of corresponding features of a present location to result in a plurality of comparisons; and
identifying the present location as the target location if the plurality of comparisons concludes that the present location is the target location.

13. The method of claim 12, further comprising updating a database record of properties of identifying features of the target location with a property of at least one identifying feature of the present location if the present location has been identified as the target location, wherein the database record is identified by a unique digital identifier.

14. The method of claim 12, wherein the plurality of identifying features of the target location includes at least one visible exterior feature of a building at the target location.

15. The method of claim 12, wherein the plurality of identifying features of the target location includes a walking profile of a route approaching the target location.

16. A method for confirming arrival at a target location, the method comprising:
generating a comparison of a profile of wireless communication networks expected to be detectable at the target location with a profile of wireless communications networks detected at a present location; and
identifying the present location as the target location if the comparison concludes that the present location is the target location.

17. The method of claim 16, wherein the profile of wireless communication networks expected to be detectable at the target location includes one or more SSIDs or BSSIDs.

18. The method of claim 16, wherein the profile of wireless communication networks expected to be detectable at the target location includes signal strengths, at the target location, of the wireless communications networks.

19. The method of claim 16, wherein the profile of wireless communication networks expected to be detectable at the target location includes radiofrequencies of the wireless communications networks.

20. The method of claim 16, wherein the profile of wireless communication networks expected to be detectable at the target location includes at least one vehicle-based WiFi network.
